(19) United States
(12) Patent Application Publication
(10) Pub. No.: US 2010/0185627 A1
(43) Pub. Date: Jul. 22, 2010

(54) SORTING METHOD OF MULTIMEDIA FILES

(75) Inventor: Ming-Chung Se, Taipei County (TW)

Correspondence Address: J C PATENTS, 4 VENTURE, SUITE 250, IRVINE, CA, 92618, US

(73) Assignee: Kinpo Electronics, Inc., Taipei County (TW)

(21) Appl. No.: 12/352,270

(22) Filed: Jan. 12, 2009

(51) Int. Cl. G06F 7/08; G06F 17/30

(52) U.S. Cl. 707/752; 707/E17.009

(57) ABSTRACT

A sorting method of multimedia files is disclosed. The method uses EXIF information parameters, image characteristic parameters and file property parameters to automatically sort massive multimedia files. In addition, a sorting mark containing a sorting name, a filename, a date parameter and a file location is displayed on the browsing frame, which is beneficial for a user to conveniently manage and browse the massive multimedia files.

### BACKGROUND OF THE INVENTION

1. Field of the Invention

The present invention generally relates to a sorting method of files, and more particularly, to a sorting method of multimedia files.

2. Description of Related Art

Along with the continuous evolution and improvements of electronic science and technology and the manufacturing technology thereof, information products with more humanized features and powerful functions are ceaselessly upgraded. In particular, along with combining a digital camera with a handset together, digital cameras have gained a significant popularization rate. A current digital camera even integrates the positioning function of global positioning system (GPS) therein so as to make a photo file contain positioning information.

In the popularization stream of handset, digital camera and digital video camera today, many people take advantage of digital cameras for recording dribs and drabs or interesting events of personal lives. Virtually and step by step, a great deal multimedia files are gathered; in particular, after a travel, people may astonish with the great quantity of the photos he or she has accumulated. Due to a great pile of the photos, a user is hard to locate a desired photo during organizing or browsing the photos, and a current browser is also unable to conduct active sorting according to the types or the contents of the photos.

### SUMMARY OF THE INVENTION

Accordingly, the present invention is directed to a sorting method of multimedia files used to establish a archive database after sorting the multimedia files according to the filenames, the image characteristics or the EXIF (exchangeable image file format) information thereof, so that a user can quickly browse the photos and locate desired multimedia files.

The present invention provides a sorting method of multimedia files, and the method includes following steps: providing an option list of setting for setting a sorting parameter, wherein the sorting parameter includes an EXIF information parameter, an image characteristic parameter and a file property parameter; capturing a plurality of multimedia files in a database and then conducting sorting on the captured multimedia files according to the sorting parameter; saving the sorted multimedia files into a database or using the database to establish a file index link; for searching purpose, providing a user interface for a user to select or input a searching condition and the logic relationship thereof (for example, “sun” AND “USA” wherein the location is determined according to the GPS information contained in the photos OR “aperture value less than F2.8” NOT “figures” which means no figures to be searched AND “later than xxxx date”); after entering the above-mentioned searching information, reading the sorted multimedia files to display the multimedia files in a display frame; meanwhile, displaying a sorting mark in the displaying frame, wherein the sorting mark has a sorting name, a filename, a date parameter and a file location, displaying an icon of image characteristic corresponding to the thumbnail or figure of the displayed multimedia file so that the user can clearly understand which category the currently browsed file belongs to and displaying a geological sketch of the regions of USA for showing the regions of browsed photos. By using the above-mentioned method, a user can rapidly get the desired one to be browsed from thousands of image files.

In an embodiment of the present invention, the above-mentioned EXIF information parameter includes a camera model, an aperture, a shutter speed, an ISO sensitivity, a date with time, a pair of GPS coordinates and a voice memo. The image characteristic parameter includes sea/beach, the sun, closed portrait, animal, snow scene, mountain, ship, figure, flower, smile expression, building and vehicle. The file property parameter includes a file creation date, a main filename, an initial of main filename and a sub filename. The sorting parameter further includes a logical combination of the EXIF information parameter, the image characteristic parameter and the file property parameter.

In an embodiment of the present invention, the step of saving the sorted multimedia files into the database further includes compressing the sorted multimedia files.

In an embodiment of the present invention, the step of reading the database to display the multimedia files according to the searching information further includes displaying the thumbnails of the multimedia files and step by step adjusting the speed of refreshing a frame of the thumbnails according to a browsing speed of user.

In an embodiment of the present invention, the step of displaying the sorting mark in the displaying frame further includes step by step adjusting a transparency, a displaying dimension and a font size of the sorting mark according to a browsing speed of user, because when an end user repeatedly presses down a key for browsing, the system would speed up the speed of browsing pictures, so that the sorting mark needs to be timely magnified for the end user to easily recognize the progressing of the picture's sorting mark.

In an embodiment of the present invention, the searching information herein is corresponding to the EXIF information parameter, the image characteristic parameter and the file property parameter.

In an embodiment of the present invention, the above-mentioned sorting method further includes displaying a thumbnail corresponding to the displayed multimedia files in the displaying frame.

In an embodiment of the present invention, the multimedia file herein includes a photo file or an audio/video file.

Based on the described above, the present invention is able to sort a great deal of multimedia files, so that a user can use a user interface to quickly browse the multimedia files of different categories (for example, photos or audio/video files) and locate the desired multimedia files. The present invention can assist the user with sorting numerous photos and automatically establishing the corresponding database so that the user can easily manage the multimedia files.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a sorting system of multimedia files according to an embodiment of the present invention.

FIG. 2 is a diagram of a browsing frame according to the embodiment.

FIG. 3 is a flowchart of the sorting method of multimedia files according to another embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

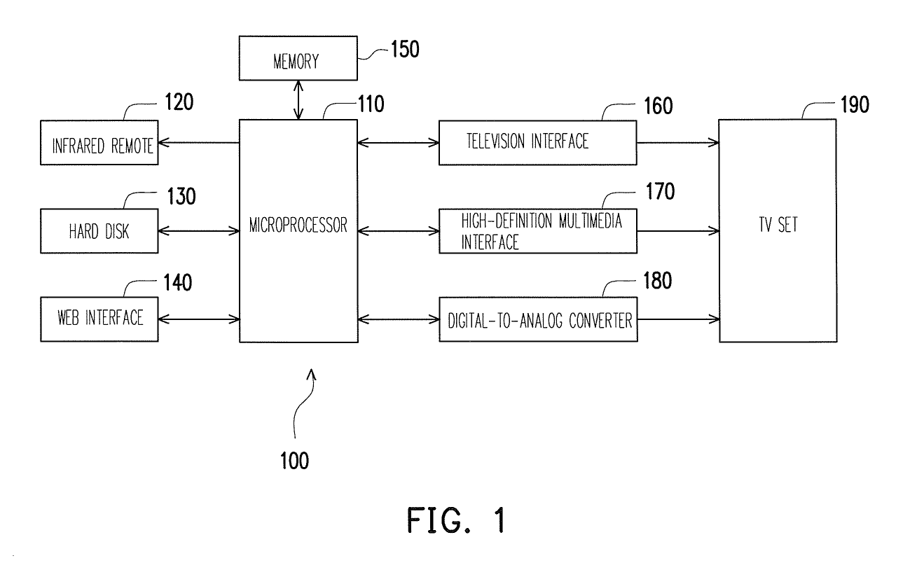

FIG. 1 is a block diagram of a sorting system of multimedia files according to an embodiment of the present invention. Referring to FIG. 1, a sorting system of multimedia files 100 includes a microprocessor 110, an infrared remote 120, a hard disk 130, a web interface 140, a memory 150, a television interface 160, an HDMI (high-definition multimedia interface) 170 and a digital-to-analog converter (DAC) 180. The microprocessor 110 herein is coupled between the above-mentioned components for reading data in the hard disk 130 or the memory 150, or for writing data into the hard disk 130 or the memory 150. The television interface 160, the HDMI 170 and the DAC 180 are mainly to deliver the multimedia files into a TV set 190 for displaying. The multimedia files are, for example, photos or audio/video files.

Taking photos as example, after a user saves photos into the hard disk 130, the microprocessor 110 would capture the photo files in the hard disk 130 for sorting them. The sorting system of multimedia files 100 provides an option list of setting used for the user to set the entries or parameters of sorting, for example, EXIF information parameter, image characteristic parameter or file property parameter. The user defines the classified entries according to the relevant information in the EXIF information parameter, such as camera model, aperture, shutter speed, ISO sensitivity, date with time, GPS coordinates and voice memo. In more details for example, the user can put all photos shoot nightly into a same classification, so that the sorting system of multimedia files 100 can judge whether or not a photo is shoot in nightly by means of the EXIF information parameter contained in a photo file and can accordingly create a database to link all the relevant photo files. The user can also sort photo files based on the country where the photos are taken, wherein the Georeference-based GPS coordinates are used to determine the place with a specific country where a photo is taken. In short, the sorting system of multimedia files 100 conducts sorting on the photo files in the hard disk 130 according to the set sorting parameter and creates database of linking between (i.e., establishing a file index link for linking the multimedia files).

In addition to the above-mentioned sorting entries covered by the EXIF information parameter, the sorting system of multimedia files 100 can further sort the multimedia files against the image characteristic and the file property thereof, wherein the image characteristic parameter includes sea and beach, the sun, closed portrait, animal, snow scene, mountain, ship, figure, flower, smile expression, building and vehicle, and the like; the file property parameter includes file creation date, main filename, initial of main filename and sub filename. The user is allowed to select some of required sorting entries and use logic operators (for example, AND, OR, etc.) combining the above-mentioned parameters to set out new sorting entries; for example, a new sorting entry related to the photos shoot within a specific period of time and with snow scene.

It should be noted that in terms of sorting based on main filename, the sorting system of multimedia files 100 can further take advantage of the apposition methodology for sorting. For example, ‘ball’, ‘basketball’ and ‘NBA’ can be seen as the same classification for sorting. In addition, the source of the above-mentioned photo files is not limited to the hard disk 130; in fact, the microprocessor 110 can be online through the web interface 140 to download the desired photo files from the web, therefore, the web can be counted as another source thereof as well.

The microprocessor 110 in the sorting system of multimedia files 100 is mainly in charge of sorting operations. When a photo file needs to be exported to the TV set 190, the microprocessor 110 would save the thumbnail or the index value of the corresponding photo file into the memory 150, followed by displaying the corresponding photo according to the user's operation. The sorting system of multimedia files 100 makes a user interface displayed on the TV set 190, so that the user can input a piece of searching information, the sorting system of multimedia files 100 would read the database after the sorting according to the input searching information and the sorted photo file would be displayed. The searching information can be a single condition, for example, snow scene, taking date or country where the photo is taken; the searching information can be a logical combination of all the detailed sorting entries contained in the EXIF information parameter, the image characteristic parameter and the file property parameter, for example, the searching information simultaneously defining a taking date and an aperture.

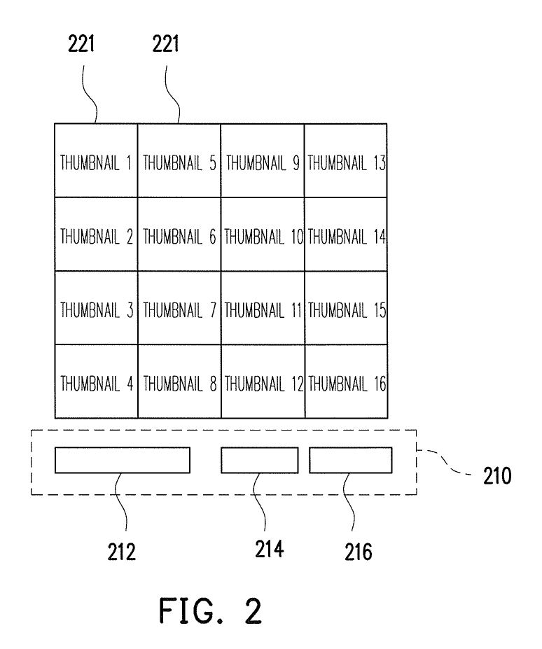

To make a user conveniently browse a great deal of photos, a sorting mark is used in the embodiment and the sorting mark is displayed in a displaying frame. The sorting mark contains the information related to the presently displayed file, such as sorting name, filename, date parameter and file location. FIG. 2 is a diagram of a browsing frame according to the embodiment. Referring to FIG. 2, a displaying frame includes a plurality of displaying areas 221. Taking 4×4 displaying areas as an example, there are 16 displaying areas 221 in a displaying frame for displaying 16 thumbnails 1-16, which can be forward displayed or backward displayed according to the index values or the sequence of names and the embodiment does not limit the displaying sequence. The user can further manipulate the infrared remote 120 to define the speed and direction of browsing. When the user selects a desired thumbnail, the sorting system of multimedia files 100 displays the corresponding photo file according to the selected thumbnail.

The sorting mark 210 is shown within the lower area of the displaying frame. The displayed information contained in the sorting mark 210 includes sorting name 216, date parameter 214, file location 212 or filename according to the classification of the presently displayed picture. The user is allowed to define the entries to be displayed and the specific displaying area contained in the sorting mark 210 by means of the user interface, which the embodiment is not limited to.

It should be noted that, during displaying, the sorting mark 210 is able to adjust the displaying format thereof, such as the transparency, the displaying dimension and the font size inside the sorting mark step by step according to the browsing speed of the user, so that the user can clearly understand the presently browsed entries and the real progressing. When an end user repeatedly presses down a key for browsing, the system would speed up the speed of browsing pictures, therefore, the sorting mark needs to be timely magnified for the end user to easily recognize the progressing of the picture's sorting mark.

Besides, the sorting system of multimedia files 100 would step by step adjust the speed of refreshing a frame of the thumbnails according to a browsing speed of user to match the need of the user. For example, when a user durably browses the thumbnails in forward direction or backward direction, the sorting system of multimedia files 100 would speed up the speed of refreshing a frame step by step to shorten the refreshing period of the thumbnails; when a user takes a pause to browse or slows down the browsing speed, the sorting system of multimedia files 100 would reduce the speed of refreshing a frame step by step to lengthen the refreshing period of the thumbnails. In this way, the embodiment can take the most appropriate speed of refreshing a frame to match the browsing speed of the user for browsing convenience.

To further enhance the browsing speed of the user, the sorting system of multimedia files 100 can indicate which classification the presently browsed photo belongs to by using a thumbnail, and the thumbnail, for example, the thumbnail No. 16, is displayed in a frame. In other words, the thumbnail No. 16 is specially used to indicate the classification of the presently displayed thumbnails No. 1-No. 15, so that the user can visually obtain the presently browsing information. During browsing, the thumbnails No. 1-No. 15 would be refreshed according to arrangement sequence thereof in the database; accordingly, the thumbnail No. 16 is also refreshed in response to the classification of the thumbnails No. 1-No. 15. Moreover, during browsing, the thumbnail No. 16 can make the user more clearly get the presently browsing progressing through text and symbol contained therein, wherein the transparency, the font size and the symbol size contained in the thumbnail No. 16 can be adjusted in response to the browsing speed for enhancing the recognisability and the readability.

The above-mentioned sorting system of multimedia files 100 can be integrated into a digital TV set, a computer or a handset device, for example, a mobile phone or a digital camera. The embodiment can be implemented by using software, and the operation resource in a current handset device can be used for sorting data, searching and displaying.

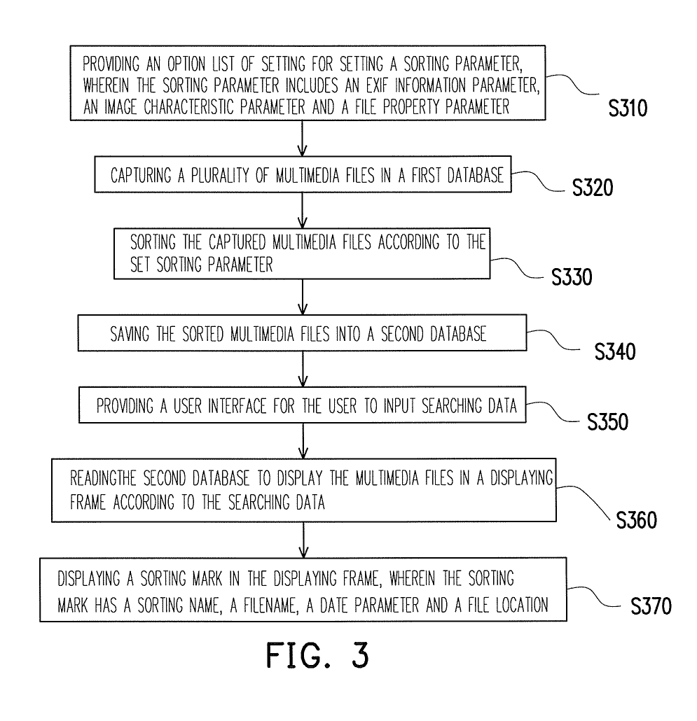

According to the above-mentioned explanations of FIGS. 1 and 2, a sorting method of multimedia files is deduced according to the present invention, as shown by FIG. 3. FIG. 3 is a flowchart of the sorting method of multimedia files according to another embodiment of the present invention. The method includes following steps. First in step S310, an option list of setting is provided for setting a sorting parameter, wherein the sorting parameter includes an EXIF information parameter, an image characteristic parameter and a file property parameter. Next in step S320, the user can set the sorting parameter through the provided option list of setting; when the sorting parameter is not set by the user, the multimedia files can be sorted according to the preset parameter; and then, a plurality of multimedia files in a first database are captured. Then in step S330, the captured multimedia files are sorted according to the set sorting parameter.

After the sorting in step S340, the sorted multimedia files are saved into a second database. Further in step S350, a user interface is provided for the user to input searching data. Furthermore in step S360, the sorting system of multimedia files reads the multimedia files in the second database according to the searching data so as to display the corresponding thumbnails or figures in a displaying frame. Meanwhile in step S370, a sorting mark is displayed in the displaying frame, wherein the sorting mark has the information related to the presently displayed file, such as a sorting name, a filename, a date parameter and a file location. The other implementation details of the sorting method of multimedia files can refer the explanations of FIGS. 1 and 2, anyone skilled in the art can easily deduce the implementation details of the sorting method of multimedia files according to the above-mentioned explanations, which are omitted herein for simplicity.

In summary, the present invention provides a sorting method of multimedia files, which uses the information related the photos, such as the EXIF information parameter, the image characteristic parameter and the file property for sorting parameter. The method can display a corresponding sorting mark in the browsed frame so that the user can more conveniently manage massive multimedia files and be adware of the classification of the presently browsed photo. The present invention is able to make a user easily organize the massive multimedia files and create a personalized archived sorting system.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A sorting method of multimedia files, comprising:
providing an option list of setting for setting a sorting parameter, wherein the sorting parameter comprises an EXIF information parameter, an image characteristic parameter and a file property parameter;
capturing a plurality of multimedia files in a first database;
conducting sorting on the captured multimedia files according to the sorting parameter;
saving the sorted multimedia files into a second database;
providing a user interface to input a piece of searching information;
reading the second database to display the multimedia files in a display frame according to the searching information; and
displaying a sorting mark in the displaying frame, wherein the sorting mark has a sorting name, a filename, a date parameter and a file location.

2. The sorting method of multimedia files as claimed in claim 1, wherein the EXIF information parameter comprises a camera model, an aperture, a shutter speed, an ISO sensitivity, a date with time, a pair of GPS coordinates and a voice memo.

3. The sorting method of multimedia files as claimed in claim 1, wherein the image characteristic parameter comprises sea/beach, the sun, closed portrait, animal, snow scene, mountain, ship, figure, flower, smile expression, building and vehicle.

4. The sorting method of multimedia files as claimed in claim 1, wherein the file property parameter comprises a file creation date, a main filename, an initial of main filename and a sub filename.

5. The sorting method of multimedia files as claimed in claim 1, wherein the sorting parameter further comprises a logical combination of the EXIF information parameter, the image characteristic parameter and the file property parameter.

6. The sorting method of multimedia files as claimed in claim 1, wherein the step of saving the sorted multimedia files into the second database further comprises:
compressing the sorted multimedia files.

7. The sorting method of multimedia files as claimed in claim 1, wherein the step of reading the second database to display the multimedia files according to the searching information further comprises:
displaying the thumbnails of the multimedia files.

8. The sorting method of multimedia files as claimed in claim 7, wherein the step of reading the second database to display the multimedia files according to the searching information further comprises:
adjusting the speed of refreshing a frame of the thumbnails step by step according to a browsing speed of user.

9. The sorting method of multimedia files as claimed in claim 7, wherein the step of displaying the sorting mark in the displaying frame further comprises:
adjusting a transparency of the sorting mark step by step according to a browsing speed of user;
adjusting a displaying dimension of the sorting mark step by step according to a browsing speed of user; and
adjusting a font size of the sorting mark step by step according to a browsing speed of user.

10. The sorting method of multimedia files as claimed in claim 1, wherein the searching information is corresponding to the EXIF information parameter, the image characteristic parameter and the file property parameter.

11. The sorting method of multimedia files as claimed in claim 1, further comprising:
displaying a thumbnail corresponding to the displayed multimedia files in the displaying frame.

12. The sorting method of multimedia files as claimed in claim 1, wherein the multimedia file comprises a photo file or an audio/video file.

13. The sorting method of multimedia files as claimed in claim 1, wherein the searching parameter further comprises a logical combination of the EXIF information parameter, the image characteristic parameter and the file property parameter.

14. The sorting method of multimedia files as claimed in claim 1, wherein the step of saving the sorted multimedia files into the second database further comprises:
establishing a file index link for linking the multimedia files.
